(19) United States
(12) Patent Application Publication
(10) Pub. No.: US 2011/0304086 A1
(43) Pub. Date: Dec. 15, 2011

(54) SHADOW FRAME AND MANUFACTURING METHOD THEREOF

(75) Inventors: FANG-YU LIU, Wuci Township (TW); Byung-jun Park, Wuci Township (TW); Jin-jong Su, Wuci Township (TW)

(73) Assignee: Global Material Science Co., Ltd., Wuci Township (TW)

(21) Appl. No.: 13/075,174

(22) Filed: Mar. 29, 2011

(30) Foreign Application Priority Data
Jun. 9, 2010 (TW) 099118749

(51) Int. Cl. B23Q 3/00; B23K 20/12; B23K 31/02

(52) U.S. Cl. 269/296; 228/179.1; 228/114

(57) ABSTRACT

A shadow frame and a method of manufacturing the shadow frame are disclosed. The shadow frame is utilized in photoelectrical semiconductor manufacturing processes and is utilized for fixing a glass substrate by combing with a support base used to carry the glass substrate. The shadow frame has a plurality of frame components and welding parts, and the frame components are adjoined at the welding parts to form the shadow frame. The provided shadow frame and its manufacturing method are capable of improving the utility rate of the substrate used to manufacture the shadow frame, avoiding a waste of the substrate, and thereby capable of reducing the manufacturing cost.

### TECHNICAL FIELD OF THE INVENTION

The present invention relates to a shadow frame and a shadow frame manufacturing method, and more particularly, to a shadow frame and a shadow frame manufacturing method utilizing an assembling approach.

### BACKGROUND OF THE INVENTION

In modern photoelectrical semiconductor manufacturing processes, when manufacturing electrical devices on a glass substrate, the glass substrate should be fixed so that the glass substrate would not be disturbed and the processes would not be interrupted. A rigid hollow frame of a similar size to the glass substrate is generally utilized to lay over the glass substrate and fix it. The hollow portion reveals an area of the glass substrate and the processes are carried out on that area. The said rigid hollow frame is generally called “shadow frame”.

It will be described an apparatus commonly used in photoelectrical semiconductor manufacturing processes, a plasma-enhanced chemical vapor deposition (PECVD) apparatus, for illustrating the function of shadow frame specifically.

FIG. 1 is a diagram showing a common design of plasma-enhanced chemical vapor deposition (PECVD) apparatus. In the PECVD apparatus, a diffuser 12 and a susceptor 14 are served as two electrodes. In the process of chemical vapor deposition, gases are inputted from an entrance 11, the temperature of gases is risen by a heater 17, and then the gases pass the diffuser 12 via the plural perforations on the diffuser 12. Because of the voltage difference between the diffuser 12 and the susceptor 14, the gases are ionized to form plasma 16 and a film is deposited on the glass substrate 10. Redundant gases flow out via an exit 19.

FIG. 2 is a diagram showing the arrangement of glass substrate 10, susceptor 14, and shadow frame 20 shown in FIG. 1. FIG. 3 is a diagram showing a top view of the shadow frame 20 shown in FIG. 2. In the PECVD processes, the glass substrate 10 is disposed on the susceptor 14, and the shadow frame lays over the glass substrate 10. The glass substrate 10 is pressed by a protrusion located on the inner frame of the shadow frame 20. Four connecting portions 25 on the shadow frame 20 are combined with corresponding pins (not shown) on the susceptor 14 for fixing the glass substrate 10.

Referring to FIG. 4a-4c, it will be described a conventional shadow frame and manufacturing method thereof.

As shown in FIG. 4a, a substrate 40 is provided. The material of the substrate 40 is aluminum. Aluminum is a material of light weight and the aluminum substrate 40 is easily to be moved. As shown in FIG. 4b, cut out the central portion 42 (the region circled by the dash line) of the substrate 40 and remain only the peripheral portion. The area being cut out is well designed for meeting the size requirement of shadow frame. As shown in FIG. 4c, the frame body of shadow frame is manufactured after the cutting step.

The conventional frame body is an one piece integrated structure. There are no broken faces or conjunct faces on this structure. However, the manner of cutting out the central portion of the substrate may waste a large area of the substrate. The manufacturing cost is increased thereby. This problem is more serious under the situation of applying to a glass substrate of big size.

In the history of developing display panels, the area of glass substrate is bigger and bigger. The size of shadow frame is designed in accordance to the glass substrate. Therefore, the demand for a shadow frame of large size is much higher. For the shadow frame used in the display factory, the size of shadow frame used in 8^{th} generation factory is 2800×2400 mm and the size of shadow frame used in 10^{th} generation factory is 3300×3000 mm. As the size of shadow frame is bigger and bigger, the waste of the substrate is more serious and the manufacturing cost is seriously increased when the shadow frame is mass manufactured by the conventional method.

### SUMMARY OF THE INVENTION

The main objective of the present invention is to provide a shadow frame and a shadow frame manufacturing method for improving the utility rate of the substrate, avoiding a waste of the substrate, and reducing the manufacturing cost.

According to the above objective, the present invention provides a shadow frame, which is utilized in photoelectrical semiconductor manufacturing processes, for fixing a glass substrate by combing with a support base used to carry the glass substrate, wherein the shadow frame has a plurality of frame components and welding parts, and the frame components are adjoined at the welding parts to form the shadow frame.

One of the frame components has a long edge and a short edge, and one of the welding parts is at the long edge or the short edge.

One of the frame components has a bevel edge, and one of the welding parts is at the bevel edge.

One of the welding parts has a saw-toothed welding face.

One of the frame components is selected from a group consisting of strip, trapezoid, and L-shaped frame components.

In another aspect, the present invention provides a shadow frame manufacturing method, in which the shadow frame is utilized in photoelectrical semiconductor manufacturing processes and is utilized for fixing a glass substrate by combing with a support base used to carry the glass substrate, the shadow frame manufacturing method comprising: providing a substrate; cutting the substrate into a plurality of frame components in appropriate size; and welding the frame components to adjoin them to form the shadow frame.

In the step of welding the frame components, friction stir welding (FSW) or laser assisted friction stir welding (LAFSW) is adopted.

The shadow frame manufacturing method further comprises a step of relieving stress of the shadow frame after the step of welding the frame components.

The shadow frame manufacturing method further comprises a step of anodizing the shadow frame to coat a protective film on it after the step of welding the frame components.

In the step of cutting the substrate, the substrate is cut into frame components of strip, trapezoid, or L shape, or their combination.

In the present invention, the whole piece of the substrate can be used. Therefore, the utility rate of the substrate is raised. The present invention can avoid the substrate waste and reduce the high cost due to manufacture the shadow frame. When assembling the frame components by welding, the welding strength can meet the structure strength requirement of the shadow frame. In addition, the cost of ordering a substrate of special size also can be saved.

### BRIEF DESCRIPTION OF THE DRAWINGS

The present invention will be described in details in conjunction with the appending drawings.

FIG. 1 is a diagram showing a common design of plasma-enhanced chemical vapor deposition (PECVD) apparatus.

FIG. 2 is a diagram showing the arrangement of glass substrate, susceptor, and shadow frame shown in FIG. 1.

FIG. 3 is a diagram showing a top view of the shadow frame shown in FIG. 2.

FIGS. 4a-4c are diagrams briefly showing a conventional shadow frame manufacturing method.

FIGS. 5a-5c are diagrams briefly showing the shadow frame manufacturing method of the present invention.

FIGS. 6a-6d are diagrams showing different structures of shadow frames implemented according to the present invention.

FIG. 7 is a diagram showing a shadow frame having a saw-toothed welding face implemented according to the present invention.

FIG. 8 is a flow chart showing the shadow frame manufacturing method of the present invention.

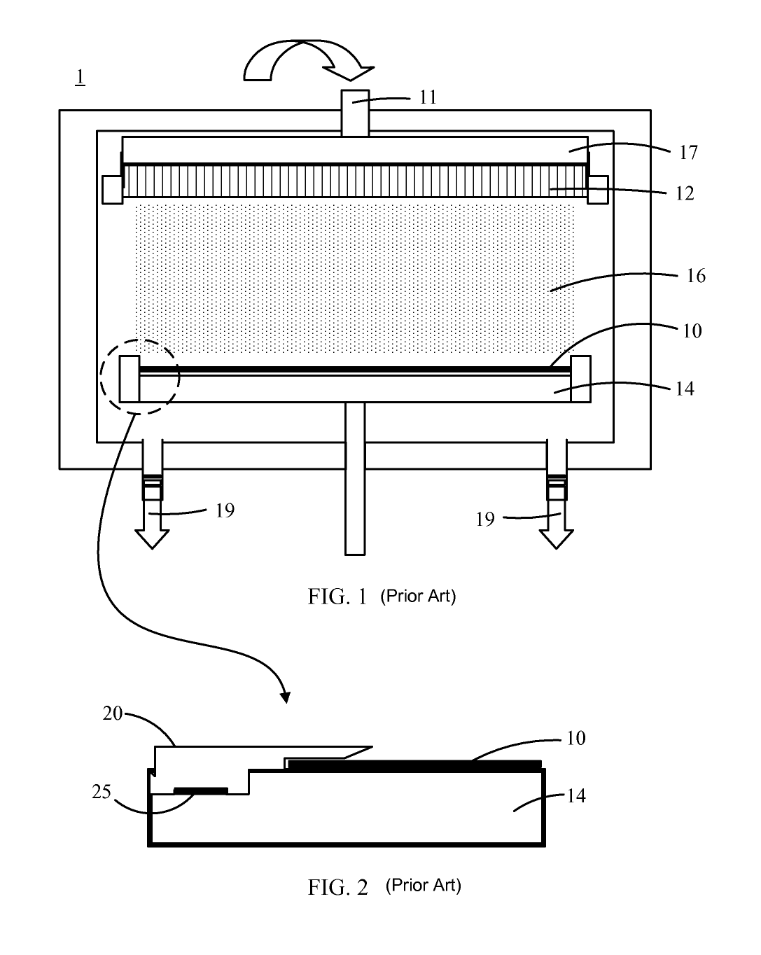

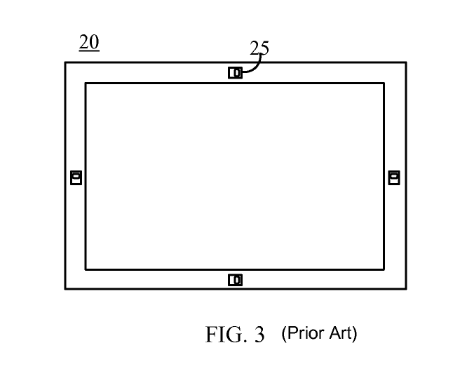

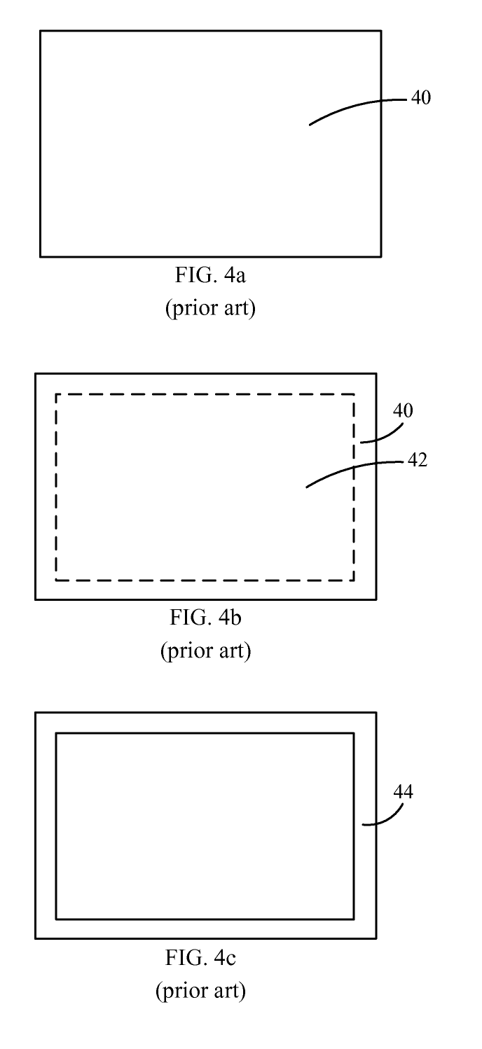

### DETAILED DESCRIPTION OF THE INVENTION

The present invention is utilized to cut the substrate into couples of components in appropriate size, and then assemble these components to form the frame of the shadow frame. The substrate is utilized almost completely. Therefore, the present invention can avoid the problem of high manufacturing cost due to the waste of the substrate.

The shadow frame manufacturing method of the present invention will be illustrated in brief as below.

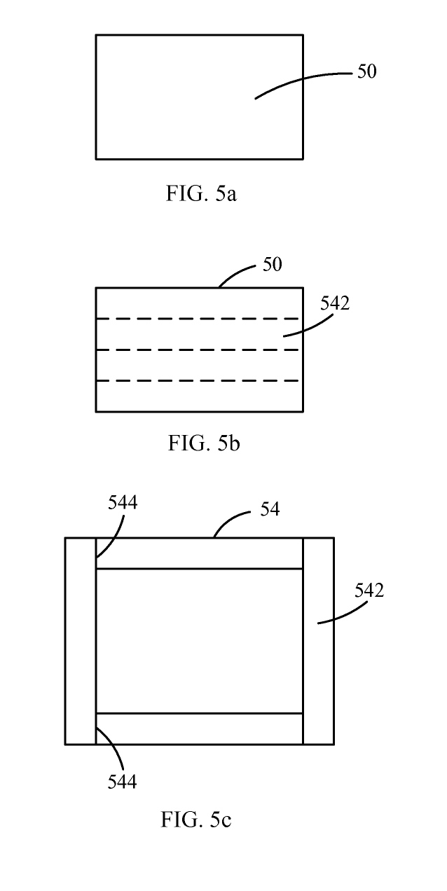

As shown in FIG. 5a, a substrate 50 is provided. The material of the substrate 50 is aluminum. The size of the substrate 50 is not limited but an appropriate size of that will be necessary.

As shown in FIG. 5b, the substrate 50 is cut. For example, the rectangular substrate 50 is cut into four components. Each of them is strip. These components are frame components 542 to be assembled to form the shadow frame. The size of each frame component 542 is designed according to the size requirement of the shadow frame.

As shown in FIG. 5c, each frame component 542 is welded to be adjoined to form the shadow frame 54. Since the adjacent frame components 542 are welded to be connected with each other, welding surfaces, or called welding parts 544, are formed therebetween.

The substrate is utilized efficiently in the present invention. The whole piece of the substrate can be used. Therefore, the utility rate of the substrate is raised. The present invention can solve the problem of the substrate waste and high cost due to manufacture the shadow frame in one piece machining. In addition, the size of the substrate is not limited in the present invention. It can be fulfilled to manufacture a shadow frame of bigger size by welding the frame components cut from a smaller piece of substrate. The cost of ordering a substrate of special size is also saved.

The frame components 542 of the present invention can be made into multiple shapes, such as strip, trapezoid, L shape, and etc. The welding parts 544 are formed at the adjacent edges of each frame component 542. When the frame component 542 has a long edge and a short edge, the welding part 544 can be at the long edge or the short edge. When the frame component 542 has a bevel edge, the welding part 544 can be at the bevel edge.

As shown in FIG. 5c, each frame component 542 is rectangular. The long edges of the two frame components 542 in the left and right and the short edges of the two frame components 542 in the middle are welded together. Therefore, at least one frame component 542 has two welding parts at one of its long edges, or at least one frame component 542 has two welding parts at both of its short edges. Concerning this structure, the cutting manner is simple. This structure is stable and is able to satisfy the strength requirement of the shadow frame 54.

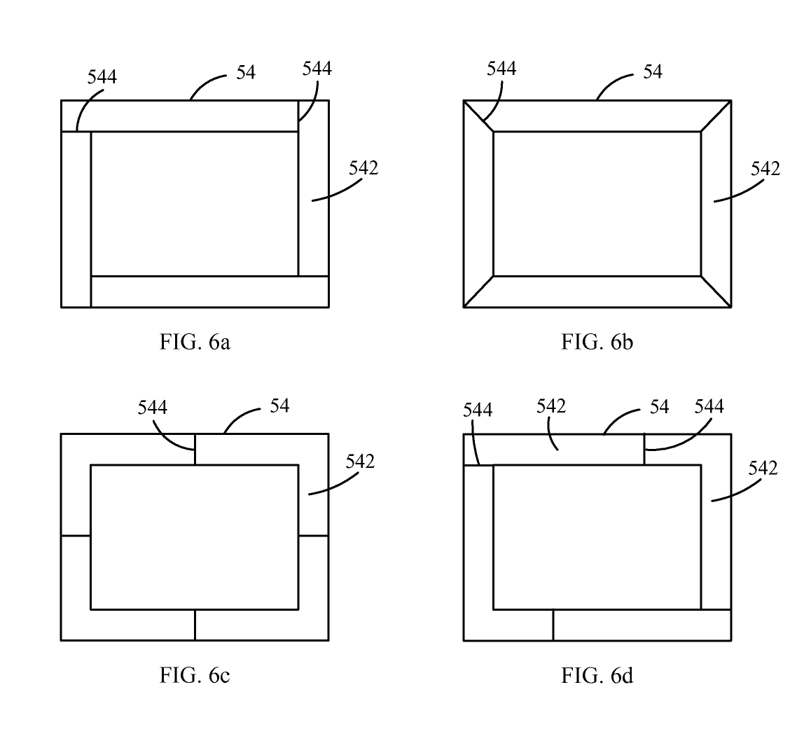

As shown in FIG. 6a, each frame component 542 is rectangular. The long edges of each frame components 542 and the short edges of their adjacent frame components 542 are welded together. The short edges of each frame components 542 and the long edges of their adjacent frame components 542 are welded together. Therefore, at least one frame component 542 has welding parts 544 at one of its long edges and one of its short edges.

As shown in FIG. 6b, each frame component 542 is trapezoid. The adjacent frame components 542 are welded at the bevel edges. Therefore, at least one frame component 542 has welding parts 544 at its bevel edges.

As shown in FIG. 6c, each frame component 542 is made as L shape. The heads and tails of each frame component 542 are welded to the adjacent frame components 542. Therefore, at least one frame component 542 has welding parts 544 at its head or its tail.

As shown in FIG. 6d, two frame components 542 are strip and the other two frame components 542 are made as L shape. The long edges and short edges of the strip frame components 542 are welded to the head or the tail of the L-shaped frame components 542. Therefore, at least one strip frame component and one L-shaped frame component have welding parts at their adjacent edges.

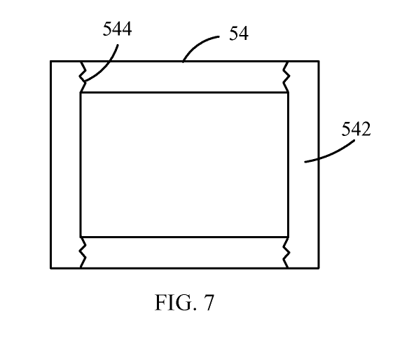

As shown in FIG. 7, the welding part 544 of two adjacent frame components 542 can be a saw-toothed welding face. The saw-toothed welding face can increase welding intensity since it has a bigger welding area. The saw-toothed welding face can be implemented to the frame components mentioned above, or other frame components of different structures.

In the present invention, the welding part 544 is not limited to be presented in the form of straight line. The welding part 544 also can be presented in a form of skew line.

In the present invention, the frame components 544 of the shadow frame 54 are not limited to have only one shape. The frame components of different shapes and different sizes can be a combination to construct the shadow frame 54.

In the present invention, it is not limited to form one shadow frame 54 by cutting one substrate 50 into four frame components 542 and assembling them together. It also can provide two substrates 50, cut each of them into six frame components 542, and assemble these frame components 542 to form three shadow frames 54. Other cutting manners or combinations can be implemented as well.

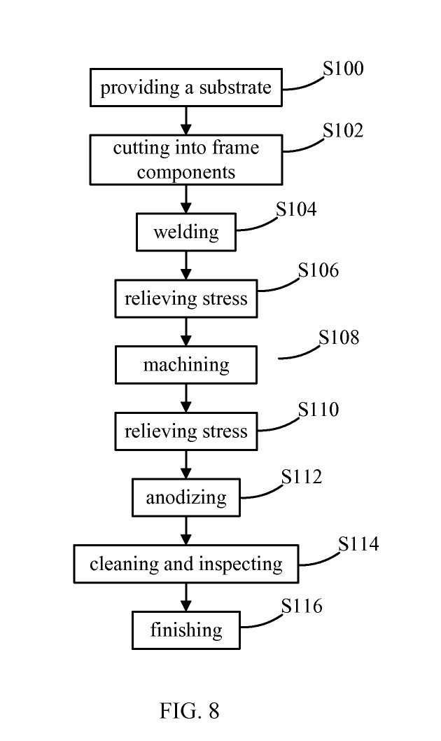

The shadow frame manufacturing method of the present invention will be described in detail in conjunction with FIG. 8.

Step S100:

In this step, a substrate is provided. The size of the substrate is not limited but an appropriate size of that will be necessary. The material of the substrate is aluminum. Aluminum is a material of light weight and the aluminum substrate is easily to be moved. Aluminum suits for manufacturing the shadow frame which provides a function of fixing a glass substrate, and the aluminum shadow frame particularly suits for utilizing in photoelectrical semiconductor manufacturing processes while manufacturing a display panel of big size.

Step S102:

In this step, the size of each frame component is determined according to the size requirement of shadow frame and the size of provided substrate. After determining size of each frame component, cut the substrate so that the frame components are made as required.

Step S104:

In this step, weld the frame components cut from the substrate in Step S102 to adjoin them to form the shadow frame. In the welding step, some welding approaches can be adopted, such as (1) tungsten inert gas welding (TIG welding), (2) laser welding, and (3) friction stir welding (FSW). FSW is a solid-state joining process and it makes the work pieces to be butted together by stress. Frictional heat is generated and it heats the metal material of the work pieces to a high temperature. Strong junction is thereby formed between the work pieces by the mechanical mixing process carried out by a stir tool. FSW has several advantages over traditional fusion welding manners. Issues such as porosity, solidification cracking, and cracking deformation are not an issue during FSW. In addition, no solder or consumables will be need during FSW, and this leads to low environment impact. FSW very suits for aluminum, magnesium, plumbum, zinc, copper and their alloys. Since the adiabatic heat is much less during welding, the deformation is unlikely occurred even for a thin and long work piece. The process of shaping may be omitted. In this welding step, it also can adopt a manner called laser assisted friction stir welding (LAFSW). It provides laser energy to heat the work pieces at first. Therefore, smaller stirring energy is needed in the process of welding and the consumption of stir tool is reduced.

Step S108:

In this step, precise machining to the shadow frame is required. For example, the processes such as removing the remains after welding, and polishing the surface or broken sections of shadow frame are required in this step.

Steps S106 and S110:

It may process a step of relieving stress of the shadow frame after Steps S104 and S108. The stress in the frame components or in the whole frame may be unbalanced after welding or precisely machining. It may rise the temperature of the shadow frame or vibrate it to relieve the stress inside the piece.

Step S112:

In this step, the shadow frame is put into a tank filled with acid liquid. The shadow frame is anodized to be coated with a protective film. When the material of the shadow frame is aluminum, an alumina layer is formed on the surface of the shadow frame after anodizing. The alumina layer can protect the shadow frame and reduce the surface damage resulted from ion impact.

Step S114:

In this step, clean the shadow frame and inspect it to see whether structural defects exist. Test the welding strength and determine whether the strength reaches the standard.

Step S116:

In this step, when the shadow frame does not pass after examination, it should be repaired or just thrown away.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A shadow frame, utilized in photoelectrical semiconductor manufacturing processes, for fixing a glass substrate by combing with a support base used to carry the glass substrate, wherein the shadow frame has a plurality of frame components and welding parts, and the frame components are adjoined at the welding parts to form the shadow frame.

2. The shadow frame of claim 1, wherein one of the frame components has a long edge and a short edge, and one of the welding parts is at the long edge or the short edge.

3. The shadow frame of claim 1, wherein one of the frame components has a bevel edge, and one of the welding parts is at the bevel edge.

4. The shadow frame of claim 1, wherein one of the welding parts has a saw-toothed welding face.

5. The shadow frame of claim 1, wherein one of the frame components is selected from a group consisting of strip, trapezoid, and L-shaped frame components.

6. A shadow frame manufacturing method, in which the shadow frame is utilized in photoelectrical semiconductor manufacturing processes and is utilized for fixing a glass substrate by combing with a support base used to carry the glass substrate, the shadow frame manufacturing method comprising:
providing a substrate;
cutting the substrate into a plurality of frame components in appropriate size; and
welding the frame components to adjoin them to form the shadow frame.

7. The shadow frame manufacturing method of claim 6, wherein in the step of welding the frame components, friction stir welding (FSW) or laser assisted friction stir welding (LAFSW) is adopted.

8. The shadow frame manufacturing method of claim 6, further comprising a step of relieving stress of the shadow frame after the step of welding the frame components.

9. The shadow frame manufacturing method of claim 6, further comprising a step of anodizing the shadow frame to coat a protective film on it after the step of welding the frame components.

10. The shadow frame manufacturing method of claim 6, wherein in the step of cutting the substrate, the substrate is cut into frame components of strip, trapezoid, or L shape, or their combination.
